(19) United States
(12) Patent Application Publication
(10) Pub. No.: US 2026/0326576 A1
(43) Pub. Date: Oct. 22, 2026

(54) METHOD FOR OPERATING A MOTOR VEHICLE AND MOTOR VEHICLE

(71) Applicant: Dr. Ing. h.c. F. Porsche Aktiengesellschaft, Stuttgart (DE)

(72) Inventor: Nils Sauvlet, Rutesheim (DE)

(73) Assignee: Dr. Ing. h.c. F. Porsche Aktiengesellschaft, Stuttgart (DE)

(21) Appl. No.: 19/648,044

(22) Filed: Apr. 15, 2026

(30) Foreign Application Priority Data
Apr. 17, 2025 (DE) 102025115188.1

(51) Int. Cl. B60L 15/20

(52) U.S. Cl. CPC B60L 15/20; B60L 2240/16

(57) ABSTRACT

A method for operating an electrically driven motor vehicle having an electric motor as a drive unit. A simulation device is provided, by way of which a simulation of an internal combustion engine drive is carried out, wherein the simulation device simulates a warm-up phase of an internal combustion engine drive.

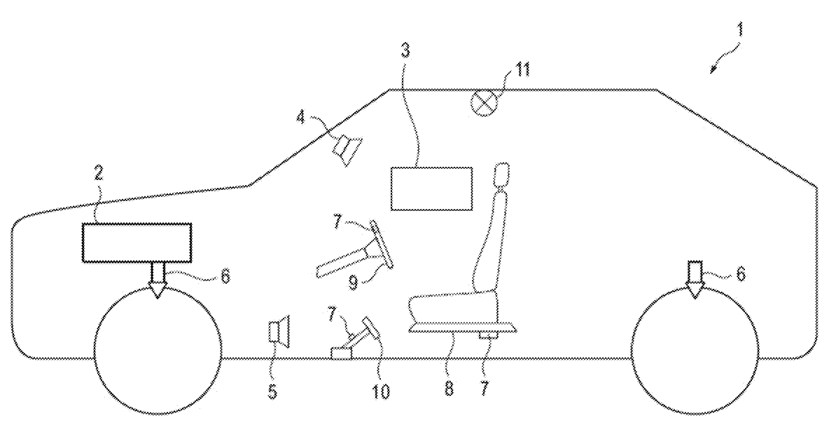

### CROSS-REFERENCE TO RELATED APPLICATION

This application claims priority to German Patent Application No. 10 2025 115 188.1, filed Apr. 17, 2025, the content of such application being incorporated by reference herein in its entirety.

### FIELD OF THE INVENTION

The invention relates to a method for operating a motor vehicle, and to a motor vehicle for carrying out the method.

### BACKGROUND OF THE INVENTION

Electrically driven motor vehicles generally have a very quiet electric drive, the noise characteristics of which do not change significantly even during operation of the motor vehicle, such that driving an electrically driven motor vehicle is often regarded as rather boring. DE 10 2011 000 175 A1, which is incorporated by reference herein, discloses an electrically driven motor vehicle which comprises a simulation device for improving driving feel and driving enjoyment, in order to simulate an internal combustion engine drive. In this context, a vibration generator and a noise generator are intended to simulate vibrations and noises of an internal combustion engine drive.

### SUMMARY OF THE INVENTION

These vibrations and noises prove to be highly monotonous and are not capable of rendering the driving of the motor vehicle less boring, in particular for drivers who are accustomed to driving a sporty motor vehicle having a powerful and large-displacement internal combustion engine.

Described herein is a method for operating an electrically driven motor vehicle which allows a motor vehicle to be driven with greater emotion. Also described herein is a motor vehicle for carrying out the method, which motor vehicle allows driving of an electrically driven motor vehicle with more emotion.

An exemplary embodiment of the invention relates to a method for operating an electrically driven motor vehicle having an electric motor as a drive unit, wherein a simulation device is provided, by means of which a simulation of an internal combustion engine drive is carried out, wherein the simulation device simulates a warm-up phase of an internal combustion engine drive. In this way, behavior of the motor vehicle can be simulated as in the case of a sporty motor vehicle having an internal combustion engine, which typically conveys greater emotions.

It is also advantageous in an exemplary embodiment if the warm-up phase comprises at least one of the following method features:
delayed engine start, in particular, only after multiple crankshaft revolutions,
idling with an unstable and/or irregular idle speed after a cold start,
increased idle speed after a cold start,
delayed torque engagement after engaging a driving gear in the transmission,
jerky (e.g., non-constant) driving behavior in the warm-up phase, in particular, with jerky (non-constant) deceleration and jerky (non-constant) acceleration,
delayed acceleration after actuation of an accelerator pedal,
limited acceleration level in the warm-up phase, and/or
increased operating forces at the steering and/or at the brake pedal.

By means of these measures, it is perceptible acoustically, haptically, and optically to the driver and the occupants of the motor vehicle that the vehicle is capable of conveying emotion and conveys a certain charm of a motor vehicle having an internal combustion engine.

It is also advantageous if the motor vehicle comprises at least one of the following controllable actuators for simulating the warm-up phase:
at least one loudspeaker in the interior,
at least one loudspeaker on the exterior of the motor vehicle,
the electric motor of the electric drive unit,
an active suspension system that may impart a body movement,
shakers on at least one seat rail, on the steering wheel, and/or on the pedal assembly,
an interior illumination,
a shiftable transmission,
a brake pedal force simulator,
a starter button, in particular, physically or virtually on a display, and/or
an electric power steering system.

Using these actuators, control of method features of a warm-up phase may be carried out such that a warm-up phase of a vehicle having an internal combustion engine is conveyed to the driver and the occupants.

It is also advantageous if at least one such actuator is controlled to simulate such a method feature.

An exemplary embodiment of the invention relates to a motor vehicle having an electric motor as a drive unit, wherein a simulation device is provided by means of which a simulation of an internal combustion engine drive is simulatable, wherein, by means of the simulation device, a warm-up phase of an internal combustion engine drive is simulatable. In this way, behavior of the motor vehicle can be simulated as in the case of a typically rather sporty motor vehicle having an internal combustion engine, which typically conveys greater emotions. The acoustic, optical, and haptic perceptions are attributed to such a motor vehicle and generate corresponding pleasant emotions in the driver and the other occupants.

It is also advantageous if the warm-up phase comprises at least one of the following method features: delayed engine start, in particular, only after multiple crankshaft revolutions and/or idling with an unstable and/or irregular idle speed after a cold start and/or increased idle speed after a cold start and/or delayed torque engagement after engaging a driving gear in the transmission and/or jerky driving behavior in the warm-up phase, in particular, with jerky deceleration and jerky acceleration and/or delayed acceleration after actuation of an accelerator pedal and/or limited acceleration level in the warm-up phase and/or increased operating forces at the steering and/or at the brake pedal. In particular, these behaviors and method features are reminiscent of the warm-up of a motor vehicle having an internal combustion engine, such that the driver and the occupants have corresponding memories and associations.

It is also advantageous if the motor vehicle comprises at least one of the following controllable actuators for simulating the warm-up phase:
at least one loudspeaker in the interior,
at least one loudspeaker on the exterior of the motor vehicle,
the electric motor of the electric drive unit,
an active suspension system that may impart a body movement,
shakers on at least one seat rail, on the steering wheel, and/or on the pedal assembly,
an interior illumination,
a shiftable transmission,
a brake pedal force simulator,
a starter button, in particular, physically or virtually on a display, and/or
an electric power steering system.

By means of these actuators, it is possible to control method features that produce increased emotion.

### BRIEF DESCRIPTION OF THE DRAWINGS

In the following, the invention is explained in detail on the basis of an exemplary embodiment with reference to the drawing.

The sole figure is a schematic representation of an exemplary embodiment of a motor vehicle for carrying out the method according to aspects of the invention.

### DETAILED DESCRIPTION OF THE INVENTION

The figure shows, in a schematic representation, an exemplary embodiment of a motor vehicle 1 for carrying out a method for operating a motor vehicle 1. The motor vehicle 1 is a motor vehicle 1 having at least one electric motor 2 as a drive unit for driving wheels of the vehicle as a propulsion system of the vehicle. A transmission, a battery, etc. may also be provided, which, however, is or are not shown.

The motor vehicle 1 also comprises a simulation device 3, by means of which a simulation of an internal combustion engine drive is simulatable, wherein, by means of the simulation device 3, a warm-up phase of an internal combustion engine drive is simulatable. It should be understood that the motor vehicle may not actually include the internal combustion engine drive.

The method according to aspects of the invention provides that the simulated warm-up phase comprises at least one of the following method features: delayed engine start, in particular, only after multiple crankshaft revolutions and/or idling with an unstable and/or irregular idle speed after a cold start and/or increased idle speed after a cold start and/or delayed torque engagement after engaging a driving gear in the transmission and/or jerky driving behavior in the warm-up phase, in particular with jerky deceleration and jerky acceleration and/or delayed acceleration after actuation of an accelerator pedal and/or limited acceleration level in the warm-up phase and/or increased operating forces at the steering and/or at the brake pedal.

For this purpose, the motor vehicle 1 comprises at least one of the following controllable actuators for simulating the warm-up phase:
at least one loudspeaker 4 in the interior,
at least one loudspeaker 5 on the exterior of the motor vehicle 1,
the electric motor 2 of the electric drive unit,
an active suspension system 6 that may impart a body movement,
shakers 7 on at least one seat rail 8, on the steering wheel 9, and/or on the pedal assembly 10,
an interior illumination 11,
a shiftable transmission,
a brake pedal force simulator,
a starter button, in particular, physically or virtually on a display, and/or
an electric power steering system.

By means of the actuators, the method features are controlled in order to simulate the warm-up of an internal combustion engine.

The method described herein may be carried out by a computer of the motor vehicle having a processor, memory, controller(s), and the appropriate software for carrying out the method steps described herein. The computer is in electrical communication (for control purposes) with a controllable actuator comprising:
at least one loudspeaker (4) in an interior of the motor vehicle,
at least one loudspeaker (5) on an exterior of the motor vehicle,
the electric motor (2) of the electric drive unit,
an active suspension system (6) that can impart a body movement,
shakers (7) on at least one seat rail (8), on a steering wheel (9), and/or on a pedal assembly (10) of the motor vehicle,
an interior illumination (11) of the motor vehicle,
a shiftable transmission of the motor vehicle,
a brake pedal force simulator of the motor vehicle,
a starter button either physically or virtually on a display of the motor vehicle, and/or
an electric power steering system of the motor vehicle.

### LIST OF REFERENCE SIGNS

1 motor vehicle
2 electric motor
3 simulation device
4 loudspeaker
5 loudspeaker
6 suspension system
7 shaker
8 seat rail
9 steering wheel
10 pedal assembly
11 interior illumination

What is claimed is:

1. A method for operating an electrically driven motor vehicle comprising a simulation device and at least one electric motor constituting an electric drive unit of the motor vehicle, the method comprising:
carrying out a simulation of an internal combustion engine drive by simulating a warm-up phase of the internal combustion engine drive.

2. The method according to claim 1, wherein the simulation of the warm-up phase comprises:
delayed engine start only after multiple crankshaft revolutions,
idling with an unstable and/or irregular idle speed after a cold start,
increased idle speed after a cold start,
delayed torque engagement after engaging a driving gear in a transmission,
jerky driving behavior in the warm-up phase with jerky deceleration and jerky acceleration,
delayed acceleration after actuation of an accelerator pedal,
limited acceleration level in the warm-up phase, and/or
increased operating forces at a steering system of the motor vehicle and/or at a brake pedal of the motor vehicle.

3. The method according to claim 1, wherein the motor vehicle further comprises at least one controllable actuator for simulating the warm-up phase, the at least one controllable actuator being:
at least one loudspeaker in an interior of the motor vehicle,
at least one loudspeaker on an exterior of the motor vehicle,
the electric motor of the electric drive unit,
an active suspension system that can impart a body movement,
shakers on at least one seat rail, on a steering wheel, and/or on a pedal assembly of the motor vehicle,
an interior illumination of the motor vehicle,
a shiftable transmission of the motor vehicle,
a brake pedal force simulator of the motor vehicle,
a starter button either physically or virtually on a display of the motor vehicle, and/or
an electric power steering system of the motor vehicle.

4. The method according to claim 3, further comprising controlling said at least one controllable actuator to carry out the simulation.

5. The method according to claim 1, wherein the electrically driven motor vehicle does not include the internal combustion engine drive.

6. A motor vehicle comprising a simulation device and at least one electric motor constituting an electric drive unit of the motor vehicle, the simulation device being configured to simulate a warm-up phase of an internal combustion engine drive device.

7. The motor vehicle according to claim 6, wherein the warm-up phase comprises: delayed engine start only after multiple crankshaft revolutions and/or idling with an unstable and/or irregular idle speed after a cold start and/or increased idle speed after a cold start and/or delayed torque engagement after engaging a driving gear in a transmission of the motor vehicle and/or jerky driving behavior in the warm-up phase with jerky deceleration and jerky acceleration and/or delayed acceleration after actuation of an accelerator pedal and/or limited acceleration level in the warm-up phase and/or increased operating forces at a steering and/or at a brake pedal of the motor vehicle.

8. The motor vehicle according to claim 6, wherein the motor vehicle comprises at least one controllable actuator for simulating the warm-up phase, the at least one controllable actuator comprising:
at least one loudspeaker in an interior of the motor vehicle,
at least one loudspeaker on an exterior of the motor vehicle,
the electric motor of the electric drive unit,
an active suspension system that can impart a body movement,
shakers on at least one seat rail, on a steering wheel, and/or on a pedal assembly of the motor vehicle,
an interior illumination of the motor vehicle,
a shiftable transmission of the motor vehicle,
a brake pedal force simulator of the motor vehicle,
a starter button either physically or virtually on a display of the motor vehicle, and/or
an electric power steering system of the motor vehicle.

9. The motor vehicle according to claim 8, wherein at least one controllable actuator is controllable for carrying out the simulation.

10. The motor vehicle according to claim 6, wherein the electrically driven motor vehicle does not include the internal combustion engine drive.
